(19) United States
(12) Patent Application Publication
(10) Pub. No.: US 2010/0060665 A1
(43) Pub. Date: Mar. 11, 2010

(54) ELECTRONIC APPARATUS WITH IMAGE ADJUSTING FUNCTION AND METHOD THEREOF

(75) Inventors: CHUAN-HONG WANG, Tu-Cheng (TW); HONG-YANG YEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO. LTD., Shenzhen City (CN); HON HAI PRECISION INDUSTRY CO., LTD., Tu-cheng (TW)

(21) Appl. No.: 12/422,306

(22) Filed: Apr. 13, 2009

(30) Foreign Application Priority Data
Sep. 11, 2008 (CN) 200810304466.5

(51) Int. Cl. G09G 5/00

(52) U.S. Cl. 345/660

(57) ABSTRACT

A method for adjusting image displayed on an electronic apparatus is provided. The method includes the step of: obtaining and comparing the aspect ratios of the to-be-displayed image and the display, determining whether the aspect ratio of the to-be-displayed image matches the aspect ratio of the display; adjusting the to-be-displayed image if the aspect ratio of the to-be-displayed image does not match the aspect ratio of the display; displaying the adjusted image in full screen.

### BACKGROUND

1. Technical Field

The present disclosure relates to an electronic apparatus with an image adjusting function and a method for adjusting image on an electronic apparatus.

2. Description of Related Art

If to-be-displayed images and a screen of a display have different aspect ratios, then the images will not fill the screen if the entire image is to be displayed. For example if the aspect ratio of the screen is greater than the aspect ratio of an image, then there will be empty borders at the left and right of the image when the entire image is sized to fit on the screen. If the aspect ratio of the screen is less than the aspect ratio of the image, then there will empty borders at the top and bottom of the image when the entire image is sized to fit the screen. Many consider these borders unsightly.

### BRIEF DESCRIPTION OF THE DRAWINGS

The components of the drawings are not necessarily drawn to scale, the emphasis instead being placed upon clearly illustrating the principles of the electronic apparatus. Moreover, in the drawings, like reference numerals designate corresponding parts throughout several views.

FIG. 1 is a block diagram of an electronic apparatus with a image adjusting function in accordance with an exemplary embodiment.

FIGS. 2-6 are schematic diagrams showing an adjusting process when an aspect ratio of a display of the electronic apparatus of FIG. 1 is greater than that of a image to be displayed on the display.

FIGS. 7-10 are schematic diagrams showing an adjusting process when the aspect ratio of the display is less than that of a image to be displayed.

FIG. 11 is a flowchart of an exemplary method for adjusting images to be displayed on the display implemented by the electronic device of FIG. 1.

### DETAILED DESCRIPTION

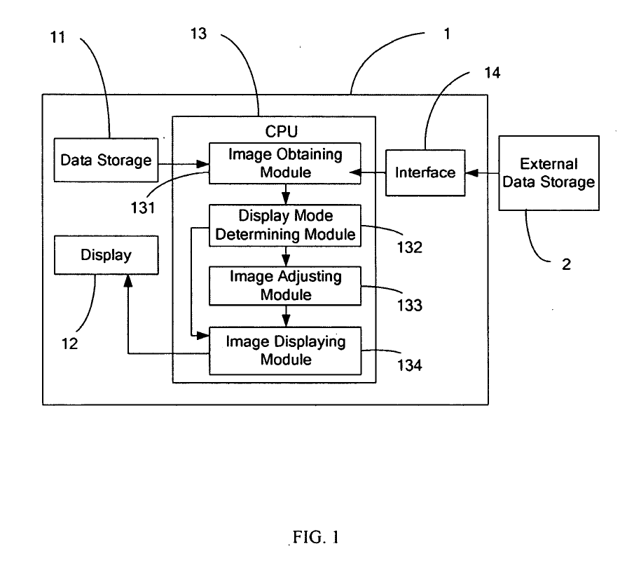

FIG. 1 is a block diagram of an electronic apparatus with a image adjusting function (hereinafter “the apparatus”) in accordance with an exemplary embodiment. The apparatus 1 is operable to connect with an external data storage 2 through an interface 14, and obtain images from the peripheral data storage 2 to display. The interface 14 can be a universal serial bus (USB) or a 1394 interface and so on. The peripheral storage 2 can be an appropriate portable device, such as a camera, a cell phone, a U-disk, or SD card.

The apparatus 1 further includes a data storage 11, a display 12, and a central processing unit (CPU) 13. The data storage 11 is for storing images. The display 12 is for displaying images. The CPU 13 includes an image obtaining module 131, a display mode determining module 132, an image adjusting module 133, and an image displaying module 134.

The image obtaining module 131 is for obtaining a to-be-displayed image from the external data storage 2 or the data storage 11. The display mode determining module 132 is for obtaining and comparing the aspect ratios of the to-be-displayed image and the display 12. If the aspect ratio of the to-be-displayed image matches the aspect ratio of the display 12, the image displaying module 14 displays the to-be-displayed image in full screen. If the aspect ratio of the to-be-displayed image does not match the aspect ratio of the display 12, the image adjusting module 133 adjusts the to-be-displayed image according to a predetermined adjusting process described below, and the image displaying module 134 displays the adjusted image.

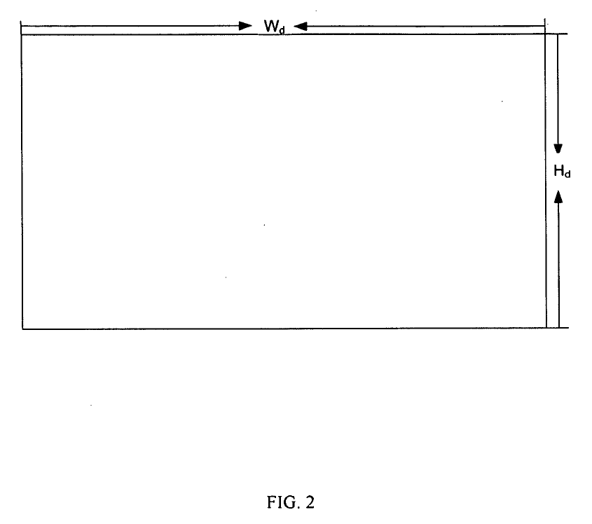

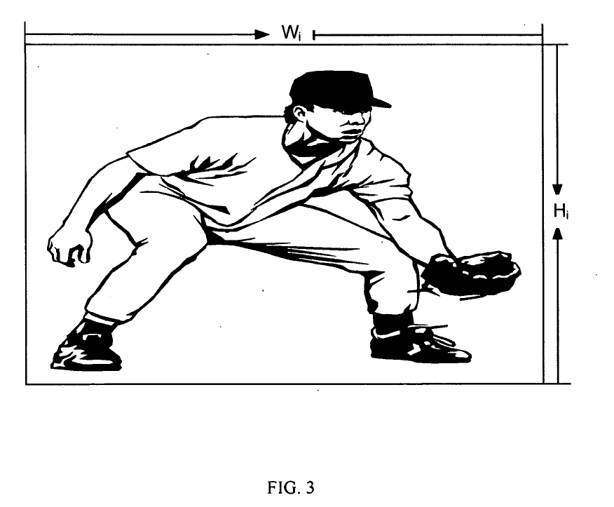

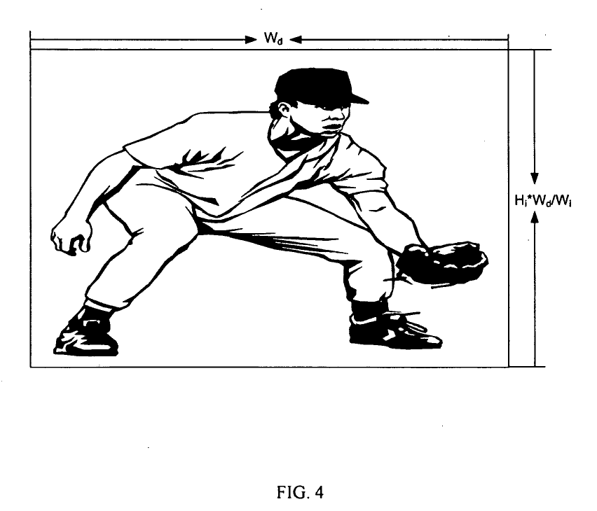

The adjusting process for when the aspect ratio of the display 12 is greater than that of the to-be-displayed image is shown in FIGS. 2-6. It is supposed that the height and the width of the display 12 respectively are H_{d} and W_{d}, and the height and the width of the to-be-displayed image are Hᵢ and Wᵢ, respectively as shown in FIG. 2 and FIG. 3, wherein W_{d}/H_{d}>Wᵢ/Hᵢ. Firstly, the image adjusting module 133 zooms in/out the to-be-displayed image until Wᵢ equals W_{d}, at which time, the height of the zoomed picture will equal Hᵢ*W_{d}/Wᵢ as shown in FIG. 4. Therefore, the height of the zoomed image is greater than the height of the display 12.

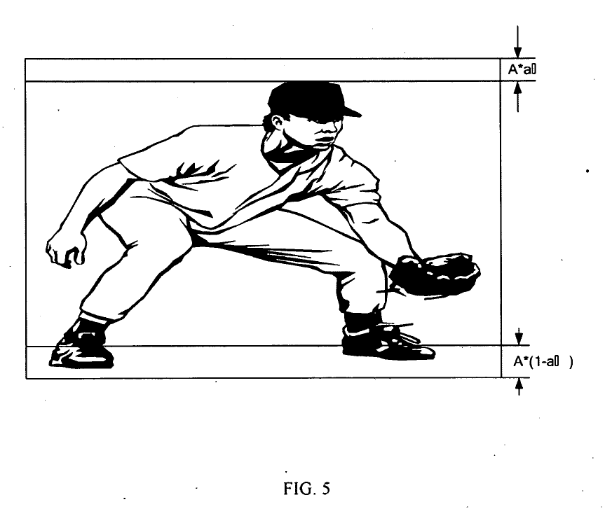

The image adjusting module 133 is for cropping parts of the zoomed image which will not appear on the display 12 (hereinafter, “excess A”). In this example, the image adjusting module 133 crops the excess A from the top part and/or bottom of the zoomed image according to predetermined parameters and/or user input. Wherein, a % of the excess A is cropped from the top part of the zoomed picture, and 1-a % of the excess A is cropped from the bottom part of the zoomed image as shown in FIG. 5. When the image adjusting module crops the image, it is desirable that the foreground of the image is not cropped. For example, if the foreground of the image is a person, the foot of the person is located in the bottom of the image, and the distance from a head of the person to the top of the image is larger than the width of the excess A, 100% of the excess A is cropped from the top part of the image, and the bottom part of the image need not to crop.

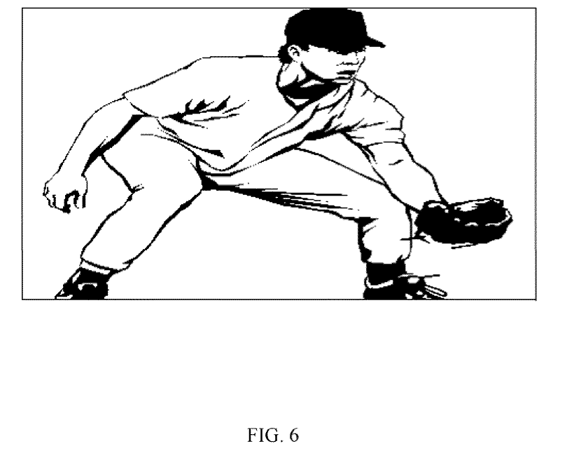

The image displaying module 134 displays the cropped image in full screen, such as shown in FIG. 6.

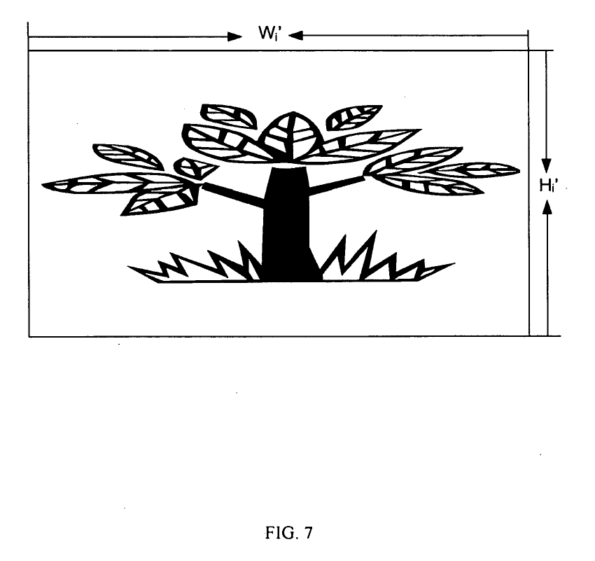

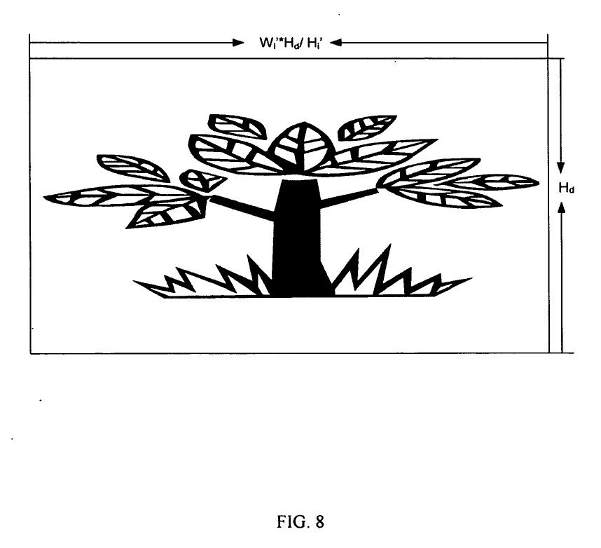

The adjusting process for when the aspect ratio of the display 12 is less than the aspect ratio of the to-be-displayed image is shown in FIGS. 7-11. It is supposed that the height and the width of the to-be-displayed image are Hᵢ′ and Wᵢ′, as shown in FIG. 7, wherein W_{d}/H_{d}<Wᵢ′/Hi′. Firstly, the image adjusting module 133 zooms in/out the to-be-displayed image until Hᵢ′ equals H_{d}, thus the width of the zoomed picture will equal Wᵢ′*H_{d}/Hᵢ′ as shown in FIG. 8. Therefore, the width of the zoomed image is greater than the width of the display 12.

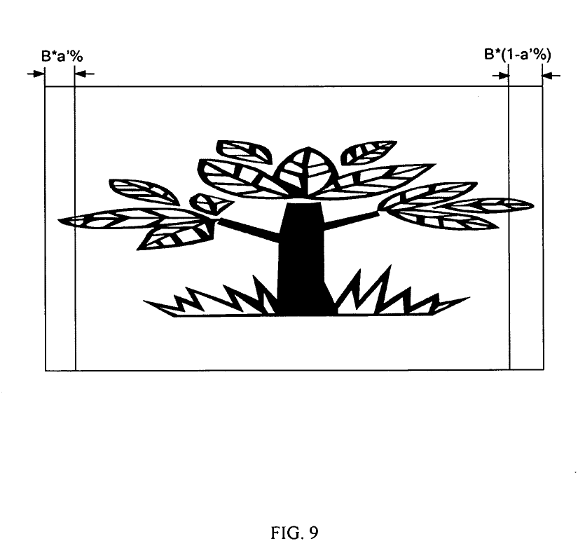

The image adjusting module 133 is for cropping parts of the zoomed image which will not appear on the display 12 (hereinafter, “excess B”). In this example, the image adjusting module 133 crops the excess B from the left-most part and/or right-most part of the zoomed image according to predetermined parameters and/or user input. Wherein, a′% of the excess B is cropped from the left-most part of the zoomed picture and 1-a′% is cropped from the right-most part of the zoomed image, such as shown in FIG. 9. When the image adjusting module crops the image, it is advisable that foreground of the image is not cropped.

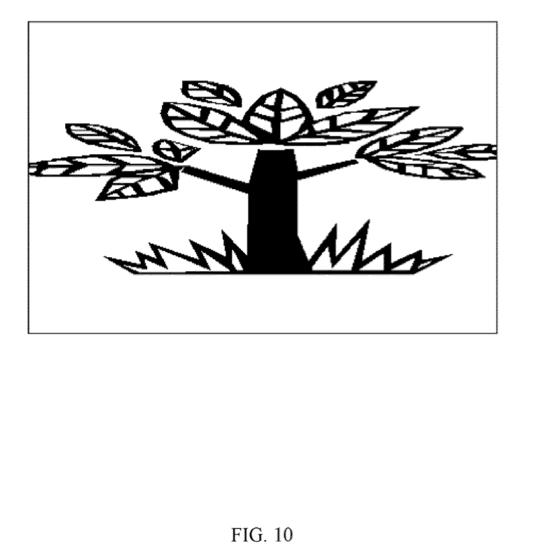

The image displaying module 134 displays the cropped image in full screen, such as shown in FIG. 10.

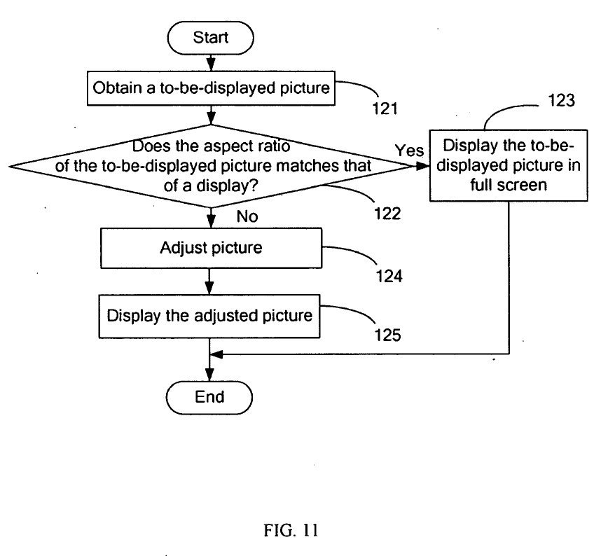

FIG. 11 is a flowchart of an exemplary method for adjusting the image displayed on the apparatus. In step S121, the image obtaining module 131 obtains the to-be-displayed image from the external data storage 2 or the data storage 11.

In step S122, the display mode determining mode 132 obtaining and comparing the aspect ratios of the to-be-displayed image and the display 12.

In step S123, If the aspect ratio of the to-be-displayed image matches the aspect ratio of the display 12, the image displaying module 14 displays the to-be-displayed image in full screen.

In step S124, the image adjusting module 133 adjusts the image, the adjusting process can refer to the above description of FIGS. 2-6 when the aspect ratio of the display 12 is larger than the aspect ratio of the to-be-displayed image, the adjusting process can refer to the above description of FIGS. 7-11 when the aspect ratio of the display 12 is less than the aspect ratio of the to-be-displayed image.

In step S125, the image displaying module 134 displays the cropped image in full screen.

Although the present disclosure has been specifically described on the basis of preferred embodiments, the invention is not to be construed as being limited thereto. Various changes or modifications may be made to the embodiment without departing from the scope and spirit of the invention.

What is claimed is:

1. An electronic apparatus with an image adjusting function, comprising:
a display for displaying images;
a image obtaining module for obtaining a to-be-displayed image from a data storage;
a display mode determining module for obtaining and comparing the aspect ratios of the to-be-displayed image and the display;
a image adjusting module for adjusting the to-be-displayed image if the aspect ratio of the to-be-displayed image does not match the aspect ratio of the display;
wherein when the aspect ratio of the display is greater than the aspect ratio of the to-be-displayed image, the image adjusting module zooms in/out the image to make a width of the image is equal to a width of the display, crops a first excess part of the zoomed image which will not appear on the display from the top part and/or bottom of the zoomed image according to predetermined parameters and/or user input; and
if the aspect ratio of the display is less than the aspect ratio of the to-be-displayed image, the image adjusting module zooms in/out the image to make a height of the image is equal to a height of the display, crops a second excess part of the zoomed image which will not appear on the display from the left-most part and/or right-most part of the zoomed image according to predetermined parameters and/or user input; and
a image displaying module for displaying the cropped image in full screen.

2. The apparatus as described in claim 1, wherein the data storage is comprised in the apparatus.

3. The apparatus as described in claim 1, wherein the data storage is an external data storage that is connected to the apparatus through an interface.

4. The apparatus as described in claim 1, wherein the image displaying module displays the image in full screen when the aspect ratio of the to-be-displayed image matches the aspect ratio of the display.

5. The apparatus as described in claim 1, wherein when the image adjusting module crops the image, foreground of the image is not to be cropped.

6. A method for adjusting image displayed on an electronic apparatus, comprising:
obtaining a to-be-displayed image;
obtaining and comparing the aspect ratios of the to-be-displayed image and the display;
if the aspect ratio of the display is greater than the aspect ratio of the to-be-displayed image:
zooming in/out the image to make the width of the image be equal to the width of the display; and
cropping a first excess part of the zoomed image which will not appear on the display from the top part and/or bottom of the zoomed image according to predetermined parameters and/or user input;
if the aspect ratio of the display is less than the aspect ratio of the to-be-displayed image:
zooming in/out the image make the height of the image be equal to the height of the display; and
cropping a second excess part of the zoomed image which will not appear on the display from the left-most part and/or right-most part of the zoomed image according to predetermined parameters and/or user input; and
displaying the crop image in full screen.

7. The method as described in claim 6, further comprising displaying the image in full screen when the aspect ratio of the to-be-displayed image matches the aspect ratio of the display.

8. The method as described in claim 6, wherein when cropping the image, foreground of the image is not to be cropped.
